(19) United States
(12) Patent Application Publication
(10) Pub. No.: US 2010/0291818 A1
(43) Pub. Date: Nov. 18, 2010

(54) COATING COMPOSITION AND CONSTRUCTION STRUCTURE FINISH MEMBER HAVING COATING LAYER

(76) Inventor: Jin-Jung Youn, Dongjak-gu (KR)

Correspondence Address: SHERR & VAUGHN, PLLC, 620 HERNDON PARKWAY, SUITE 320, HERNDON, VA, 20170, US

(21) Appl. No.: 12/506,689

(22) Filed: Jul. 21, 2009

(30) Foreign Application Priority Data
May 18, 2009 (KR) 10-2009-0043093

(51) Int. Cl. B32B 5/02; C08K 5/17; B32B 17/10; B32B 27/10; B32B 27/30; B32B 15/08; B32B 13/12

(52) U.S. Cl. 442/59; 524/186; 428/432; 428/511; 428/500; 428/461; 428/451

(57) ABSTRACT

Disclosed is a a coating composition capable of continuously removing volatile organic compounds (VOCs) generated from a construction finish material at a high speed, and a construction finish material comprising a coating layer obtained therefrom. The coating composition includes a metal salt which forms a metal ion when dissolved in a solvent and provides metal colloide particles when reduced, an amine compound, a reducing compound to reduce the metal salt into a metal, levulinic acid (CH₃COCH₂CH₂COOH) which is nontoxic to humans, and serves as an antimicrobial agent or an antifungal agent to kill bacteria and fungi or inhibit microorganism growth, a binder serving as an adhesive agent, and a solvent. The construction finish material includes a sheet, and a coating layer coated on the surface of the sheet.

This application claims the benefit of Korean Patent Application No. 10-2009-0043093, filed on 18 May 2009, which is hereby incorporated by reference as if fully set forth herein.

### BACKGROUND OF THE INVENTION

1. Field of the Invention

The present invention relates to a coating composition and a construction finish member having a coating layer. More specifically, the present invention relates to a coating composition capable of continuously removing volatile organic compounds (VOCs) from a construction finish material at a high speed, and a construction finish material comprising a coating layer obtained therefrom.

2. Discussion of the Related Art

In response to an increase in the demands for more convenient and comfortable living spaces, and an increase in housing density due to urbanized living spaces, removal of visual and olfactory unpleasantness, and sanitary problems due to microorganism contamination are required in order to realize comfortable and clean environment in close-type houses or buildings constructed with concrete, aluminium chassis and windows. In particular, in recent years, formaldehyde and VOCs have caused deterioration in living environments and have a serious negative effect on the human body. VOCs are organic compounds having high vapor pressures, which are present in the form of vapor in ambient air and react with nitrogen compounds to produce harmful substances such as ozone, when exposed to heat and solar light in the air. In addition, sick house syndrome caused by substances such as formaldehyde generated during construction in close-type housing and living spaces has already become a social problem. Such a problem is caused by construction materials, coating, adhesive processing, etc. Accordingly, there is a demand for removal of harmful substances generated from wallpapers, veneer, floorings, plastics, paints, fibers, non-woven fabrics, etc, and eliminating the possibility of sanitation problems related to microorganism contamination.

### SUMMARY OF THE INVENTION

Accordingly, the present invention is directed to a coating composition and a construction finish member having a coating layer that substantially obviate one or more problems due to limitations and disadvantages of the related art.

It is one object of the present invention to provide a coating composition for construction finishing, capable of reducing emission of VOCs from construction structures in housing and living spaces and preventing microorganism contamination.

It is another object of the present invention to provide a construction finish member, which is widely utilized in a variety of applications without causing any appearance variation regardless of kind and shape of the construction finish member in housing and living spaces, can be realized at low costs, and comprises a coating layer capable of reducing emission of VOCs from construction structures, and preventing microorganism contamination.

To achieve these objects and other advantages and in accordance with the purpose of the invention, as embodied and broadly described herein, provided is a coating composition including: a metal salt; an amine compound; levulinic acid (CH₃COCH₂CH₂COOH); a binder; and a solvent.

The metal salt may be present in an amount of about 0.1 to 5% by weight, the amine compound may be present in an amount of about 0.1 to 1% by weight, the levulinic acid may be present in an amount of about 0.001 to 0.1% by weight, and the binder may be present in an amount of about 0.01 to 0.5% by weight, based on the total weight of the coating composition of the present invention.

The metal salt may be selected from Mn, W, Mo, Zn, Ca, Pt, inorganic and organic acid salts thereof and combinations thereof.

The amine compound may be selected from the group consisting of aliphatic amines, aromatic amines, aralkylamines, alkanolamines and combinations thereof.

The binder may comprise polyvinylpyrrolidone and an imidazole-silane.

The imidazole-silane compound may be a reaction product of an imidazole compound selected from imidazole (C₃H₄N₂), 2-methylimidazole, 2-ethylimidazole, 2-undecylimidazole, and 2-ethyl-4-methylimidazole, with a silane compound selected from 3-glycidoxypropyltriethoxysilane (GPTS), 3-glycidoxypropyldimethoxymethylsilane, and 3-glycidoxypropylethoxydimethylsilane.

The solvent may be distilled water, an organic solvent or a combination thereof.

In accordance with another aspect, provided is a construction finish material including: a sheet; and a coating layer coated on the surface of the sheet, wherein the coating layer is made of a coating compound comprising a metal salt, an amine compound, levulinic acid, a binder, and a solvent.

The sheet may be made of a material selected from the group consisting of wood, papers, fabrics, non-woven fabrics, polymers, glasses, metals, organic and inorganic compounds and concrete.

The coating layer may be colorless and transparent.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and along with the description serve to explain the principle of the invention. In the drawing:

FIG. 1 is a sectional view illustrating an exemplary structure of a construction finish material according to an embodiment of the present invention.

### DETAILED DESCRIPTION OF THE INVENTION

Hereinafter, preferred embodiments according to the present invention will be described in detail with reference to the accompanying drawings.

This invention may, however, be embodied in many different forms and should not be construed as limited to the embodiments set forth herein. The embodiments are provided for a better understanding of those skilled in the art. In the drawings, the sizes and thicknesses of layers and regions are exaggerated for clarity. It will be understood that when an element such as a layer, region or substrate is referred to as being “on” another element, it can be directly on the other element or intervening elements may also be present.

The coating composition of the present invention comprises: a metal salt which forms a metal ion when dissolved in a solvent, and provides metal colloide particles when reduced; an amine compound, a reducing compound to reduce the metal salt into a metal; levulinic acid (CH₃COCH₂CH₂COOH) which is nontoxic in humans, and serves as an antimicrobial agent or an antifungal agent to kill bacteria and fungi or inhibit microorganism growth; a binder serving as an adhesive agent; and a solvent.

For example, the metal salt is present in an amount of about 0.1 to 5% by weight, based on the total weight of the coating composition of the present invention. The amine compound may be present in an amount of about 0.1 to 1% by weight, based on the total weight of the coating composition of the present invention. In addition, the levulinic acid may be present in an amount of about 0.001 to 0.1% by weight, based on the total weight of the coating composition of the present invention. The binder may be present in an amount of about 0.01 to 0.5% by weight, based on the total weight of the coating composition of the present invention. The solvent may be present in a residual amount of the coating composition.

The metal salt contained in the coating composition may include an active metal selected from Mn, W, Mo, Zn, Ca, Pt, inorganic and organic acid salts thereof and combinations thereof. For example, the metal salt may be a metal compound, an inorganic or organic acid salt, such as sulfate, nitrate, chlorate or acetate.

In the coating composition, the metal salt is dissolved in a solvent to form a metal ion, and provides metal colloide particles when the metal ion is reduced. The metal salt promotes both catalytic oxidation of carbon compounds and reduction of nitrogen compounds, to decompose VOCs.

For example, the metal colloide may be present in an amount of about 0.1 to 1.5% by weight, based on the total weight of the coating composition of the present invention. When precious metal (e.g., Pt) colloide is used, the Pt colloide may be present in an amount of about 0.0001 to 0.01% by weight, based on the total weight of the coating composition. When the metal colloide is used in an amount lower than 0.1% by weight, it cannot sufficiently degrade a desired level of VOCs. When the metal colloide exceeds 5% by weight, dispersion stability of the coating composition cannot be secured.

The reducing compound, i.e., amine compound contained in the coating composition, serves to reducing the metal compound present therein into metal.

Alkali metal borohydrides, e.g., sodium borohydride, hydrazine, citrate, tartrate, formate, formaldehyde and sulfoxylate derivatives, etc., which are conventionally used as a reducing agent, are environmentally harmful. On the other hand, the coating composition of the present invention comprises an amine compound which is a conventionally harmless reducing compound. The amine compound is added to the coating composition, and the resulting solution is mixed together with stiring, to reduce metal ions present in the coating composition into metals at normal temperature. As such, the amine compound present in the coating composition is harmless and enables efficient reduction of the metal compound therein at a reaction temperature of about 20 to 70° C. without using any heater or expensive irradiation apparatus.

The amine compound is selected from the group consisting of aliphatic amines, aromatic amines, aralkylamines, alkanolamines and combinations thereof. For example, the amine compound may be C₃-C₁₆ alkanolamine and specific examples thereof include methylaminoethanol, dimethylaminoethanol, triethanolamine, ethanolamine, diethanolamine, methyldiethanolamine, propanolamine, 2-(3-aminopropylamino)ethanol, butanolamine, hexanolamine, dimethylaminopropanol and dimethylethanolamine.

The levulinic acid contained in the coating composition is safe to the human body and serves as an antimicrobial agent or an antifungal agent to kill bacteria and fungi or inhibit microorgamism growth.

Quaternary ammonium salts, chlorhexidine, carbendazim, thiazole, azole and tin (Sn)-based antimicrobial/antifungal agents were reported as conventionally used organic antimicrobial agents. However, these materials have disadvantages of the lack of safety to toxicity, ecosystem destruction due to production of environmental hormones, etc. In addition, other disadvantages of these materials are reduction in antimicrobial effects due to thermal decomposition upon high-temperature processing and deterioration in product quality due to yellowing.

On the other hand, levulinic acid contained in the coating composition is harmless to humans, and exhibits antibactieriol effects against bacteria and fungi or inhibits microorgamism growth, thus being suitable for use in the component of the coating composition which is applied to housing and living places.

Levulinic acid is colorless, has lamellar crystals, is experimentally prepared by boiling starch or sugar with hydrochloric acid, and is commercially obtained by boiling cellulose with an inorganic acid. Levulinic acid is used as a starting material of methyl tetrahydrofuran, aminolevulinic acid, diphenolic acid, etc. Levulinic acid and derivatives thereof exhibit antibiotic activity. Levulinic acid is a novel antibiotic which is quite different from conventional antibiotics, and exhibits antibiotic activity against a wide range of bacteria, for example, Gram-positive, Gram-negative, yeast and drug-resistant bacteria. In particular, levulinic acid and derivatives thereof exhibit strong physiologic antibiotic activity against drug-resistant bacteria and other bacteria. Specifically, levulinic acid and derivatives thereof exhibit potent antibiotic activity to Methicillin-resistant Staphylococcus aureus (MRSA), R-pseudomonas aeruginosa and vancomycin resistant enterococci (VRE), in addition to general bacteria including Ataphylococcus aureus and Enterococcus faecium.

The binder contained in the coating composition may comprise polyvinylpyrrolidone and an imidazole-silane compound.

The polyvinylpyrrolidone constituting the binder forms a nano-filtration membrane which has intermediate properties between ultra-filtration membranes and reverse-osmosis membranes and thus permeates monovalent ions, but does not permeate polyvalent ions, to efficiently remove high-molecular weight organics as well as low-molecular weight organics, and serves as a stable adhesive agent which does not undergo hydrolysis in the presence of strong bases or acids due to superior chemical stability at a wide range of acidities.

In addition, the imidazole-silane compound constituting the binder may be obtained by reacting an imidazole compound with a glycidoxy-containing silane compound at 80 to 100° C. That is, the metal is trapped in a silane coupling agent having a metal-trapping functional group, to improve adhesion strength of the coating composition.

Examples of useful imidazole compounds include nitrogen-containing heterocyclic azole compounds, e.g., imidazole, 2-methylimidazole, 2-ethylimidazole, 2-undecylimidazole and 2-ethyl-4-methylimidazole, etc.

Examples of useful glycidoxy-containing silane compounds include 3-glycidoxypropyltriethoxysilane, 3-glycidoxypropyldimethoxymethylsilane, 3-glycidoxypropylethoxydimethylsilane, etc.

Any solvent may be used for the coating composition without particular limitation so long as it can dissolve the metal salt present in the coating composition. For example, the solvent may be water (distilled water), an organic solvent or a combination thereof. When the metal salt contained in the coating composition is a metal compound, water (distilled water) may be used as the solvent.

Table 1 shows examples of components of the coating composition and compositions thereof.

TABLE 1

| Components | Compounds (content) |
|---|---|
| Metal salt | Mn (0.6 wt %) |
| | W (0.3 wt %) |
| | Mo (0.1 wt %) |
| | Zn (0.2 wt %) |
| | Ca (0.1 wt %) |
| | Pt (5 ppm) |
| Amine compound | Diethanolamine (0.4 wt %) |
| Antibacterial/antifungal agent | Levulinic acid (0.02 wt %) |
| Binder | Polyvinylpyrrolidone (0.1 wt %) |
| | Imidazole (C₃H₄N₂) - silane (3- |
| | glycidoxypropyltriethoxysilane) |
| | compound (0.2 wt %) |
| Solvent | Distilled water (remaining wt %) |

In Table 1, the contents of the compounds are based on the total weight of the coating composition. In addition, the distilled water is present in an amount of the remaining weight except for other components of the coating composition.

The coating composition as set forth in Table 1 exhibits antibacterial effects against bacteria and fungi or inhibits microorgamism growth.

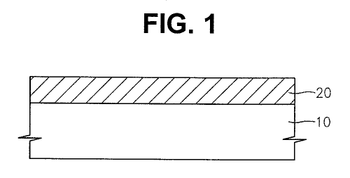

FIG. 1 is a sectional view illustrating an examplary structure of a construction finish material according to an embodiment of the present invention.

Referring to FIG. 1, the construction finish material according to the present invention comprises a sheet 10 and a coating layer 20 coated on the surface of the sheet 10.

Materials for the sheet 10 are not particularly limited and include a variety of interior or exterior construction materials. For example, the sheet 10 may be composed of a material selected from the group consisting of wood, papers, fabrics, non-woven fabrics, polymers, glasses, metals, organic and inorganic compounds and concrete.

The coating layer 20 may be produced from the coating composition of the present invention. For example, the coating composition of the present invention is sprayed on the the sheet 10 at about 20 to 70° C. (e.g., 30° C.) for several hours (e.g., about 2 hours) and is then dried and cured, to obtain a transparent coating layer 20.

The coating layer 20 continuously removes VOCs and exerts both antibacterial and antifungal activities, thus removing VOCs from the sheet 10 used as the construction finish material and preventing the sheet 10 from being contaminated by microorganicms including various bacteria and fungi. In addition, although the coating layer 20 is formed on the surface of the sheet 10, the sheet 10 maintains its original texture and color, because the coating layer 20 is colorless and transparent.

### Evaluation Example

Table 2 shows results wherein a coating layer is formed on the surface of wallpaper with the coating composition of the present invention, and removal of benzene from the wallpaper is then evaluated.

For evaluation of Table 2, the coating composition in accordance with Table 1 is coated on wallpaper (width×length=20 cm×10 cm) and is then dried and cured at a temperature of 30° C., to prepare a sample in which a transparent coating layer is formed on the wallpaper. Then, the sample wherein the coating layer is formed is placed in a 5 L deodorized container and deodorization of benzene from the container as a function of time is analyzed.

A coating layer-free wallpaper (Comparative Example, referred to as “BLANK”) is evaluated for benzene deodorization in the same manner as the sample of the present invention. The results thus obtained are shown in Table 2.

TABLE 2

| | Benzene content | Benzene content | Benzene |
|---|---|---|---|
| | (ppm) of Comprative | in the sample of | deodorization in |
| Time | Example | the present | the sample of the |
| (min) | (BLANK) (ppm) | invention (ppm) | present invention (%) |
| Initial | 20 | 20 | 0 |
| state | | | |
| 30 | 20 | 16 | 20 |
| 60 | 19.5 | 15 | 23 |
| 90 | 19 | 14 | 26 |
| 120 | 18.5 | 13.5 | 27 |

As can be seen from the results in Table 2, when a coating layer is formed on wallpaper using the coating composition of the present invention, benzene deordorization can be increased.

As apparent from the fore-going, the coating composition of the present invention is coated on a variety of construction finish materials including interior and exterior construction materials, to form a trasnaprent coating film. The transparent coating film produced from the coating composition exerts a continuous VOC removal capability and antibacterial and antifungal activities. Accordingly, the coating composition coated on interior and exterior construction materials can efficiently remove VOCs, as well as various bacteria and fungi, thus minimizing the possibility of microorganicm contamination, and providing comfortable and hygienic housing and living spaces.

In addition, the coating composition comprises composite metal salts having several to several tens of nanometer-scale fine particle size including a metal salt which is dissolved in a solvent to form metal ions and is reduced to provide metal colloidal particles, and is colorless and transparent, thus being suitable for use in the formation of coating films for construction finish materials.

Further, the coating composition is inexpensive and is used to form a coating film on construction finish materials by a simple process such as spraying without using any expensive apparatus. Accordingly, comfortable and hygienic housing and living spaces can be provided at low costs, which remove VOCs and minimize microorganism contamination.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1-10. (canceled)

11. A coating composition comprising:
a metal salt;
an amine compound;
levulinic acid (CH₃COCH₂CH₂COOH);
a binder; and
a solvent.

12. The coating composition according to claim 11, wherein the metal salt is present in an amount of about 0.1 to 5% by weight, the amine compound is present in an amount of about 0.1 to 1% by weight, the levulinic acid is present in an amount of about 0.001 to 0.1% by weight, and the binder is present in an amount of about 0.01 to 0.5% by weight, based on the total weight of the coating composition.

13. The coating composition according to claim 11, wherein the metal salt is selected from the group consisting of Mn, W, Mo, Zn, Ca, Pt, inorganic and organic acid salts thereof and combinations thereof.

14. The coating composition according to claim 11, wherein the amine compound is selected from the group consisting of aliphatic amines, aromatic amines, aralkylamines, alkanolamines and combinations thereof.

15. The coating composition according to claim 11, wherein the binder comprises polyvinylpyrrolidone and an imidazole-silane.

16. The coating composition according to claim 15, wherein the imidazole-silane compound is a reaction product of an imidazole compound selected from the group consisting of imidazole (C₃H₄N₂), 2-methylimidazole, 2-ethylimidazole, 2-undecylimidazole, and 2-ethyl-4-methylimidazole, with a silane compound selected from the group consisting of 3-glycidoxypropyltriethoxysilane (GPTS), 3-glycidoxypropyldimethoxymethylsilane, and 3-glycidoxypropylethoxydimethylsilane.

17. The coating composition according to claim 11, wherein the solvent is distilled water.

18. The coating composition according to claim 11, wherein the solvent is an organic solvent.

19. The coating composition according to claim 11, wherein the solvent is a combination of distilled water and an organic solvent.

20. A construction finish material comprising:
a sheet; and
a coating layer coated on the surface of the sheet,
wherein the coating layer is made of a coating compound comprising a metal salt, an amine compound, levulinic acid, a binder, and a solvent.

21. The construction finish material according to claim 20, wherein the sheet is made of a material selected from the group consisting of wood, papers, fabrics, non-woven fabrics, polymers, glasses, metals, organic and inorganic compounds and concrete.

22. The construction finish material according to claim 20, wherein the coating layer is colorless and transparent.
